(19) United States
(12) Patent Application Publication
(10) Pub. No.: US 2018/0232681 A1
(43) Pub. Date: Aug. 16, 2018

(54) INFORMATION PROCESSING SYSTEM, INFORMATION PROCESSING APPARATUS, AND INFORMATION PROCESSING METHOD

(71) Applicant: Kousuke MATSUURA, Hokkaido (JP)

(72) Inventor: Kousuke MATSUURA, Hokkaido (JP)

(73) Assignee: Ricoh Company, Ltd., Tokyo (JP)

(21) Appl. No.: 15/750,963

(22) PCT Filed: Aug. 22, 2016
(86) PCT No.: PCT/JP2016/003805

§ 371 Date: Feb. 7, 2018

(30) Foreign Application Priority Data
Aug. 26, 2015 (JP) 2015-166705

(51) Int. Cl. G06Q 10/06; G06F 11/34

(52) U.S. Cl. CPC G06Q 10/06398; G06F 11/3409; G06F 11/3476

(57) ABSTRACT

An information processing system for executing a job process is disclosed. The information processing system includes an acquiring unit configured to acquire an operation log of a user performance on a display screen for executing a process included in the job process, a saving unit configured to save the acquired operation log in a first storage, and a creating unit configured to create a report including information in association with the operation of the user performance on the display screen, based on the operation log stored in the first storage.

### TECHNICAL FIELD

The present disclosure relates to an information processing system, an information processing apparatus, and an information processing method.

### BACKGROUND ART

Business process management (BPM) is known as an approach in operations management techniques to manage various types of company's business operations including marketing, sales, production, and human resource management as the company's job processes to continuously improve the business processes. The business process management system (BPMS) is a known technology to implement such BPM.

The BPMS frequently include a tool called “business intelligence” to analyze a process execution history and the like to assist the improvement of the processes.

Further, there is disclosed a technology to analyze an execution history for each of activities included in the process to extract causal factor candidates of lowering job efficiency (e.g., Patent Document 1).

### CITATION LIST

### Patent Literature

[PTL 1] Japanese Patent No. 4376887

### SUMMARY OF INVENTION

### Solution to Problem

An aspect of the present invention is directed to providing a technology capable of assisting the process improvement in terms of user's operability.

In accordance with an aspect of an embodiment, there is provided an information processing system for executing a job process. The information processing system includes an acquiring unit configured to acquire an operation log of a user performance on a display screen for executing a process included in the job process; a saving unit configured to save the acquired operation log in a first storage; and a creating unit configured to create a report including information in association with the operation of the user performance on the display screen, based on the operation log stored in the first storage.

### Advantageous Effect of the Invention

According to an aspect of the present invention, there is provided a technology capable of assisting the process improvement in terms of user's operability.

### BRIEF DESCRIPTION OF DRAWINGS

FIG. 1 is a diagram illustrating a system configuration example of a job system according to an embodiment;

FIG. 2 is a schematic diagram illustrating an example of a process in the job system according to the embodiment;

FIG. 3 is a diagram illustrating a hardware configuration example of a computer in the job system according to the embodiment;

FIG. 4 is a diagram illustrating a functional configuration example of the job system according to the embodiment;

FIG. 5 is a sequence diagram illustrating an example of a log storage process in the job system according to the embodiment;

FIG. 6 is a diagram illustrating an example of a vacation leave application form;

FIG. 7 is a diagram illustrating an example of log data stored in a log temporary storage;

FIG. 8 is a diagram illustrating an example of log data stored in a log storage;

FIG. 9 is a flowchart illustrating an example of a log creating process in the job system according to the embodiment;

FIG. 10 is a flowchart illustrating an example of a report creating process in the job system according to the embodiment;

FIG. 11 is a diagram illustrating an example of report data;

FIG. 12 is a sequence diagram illustrating an example of a report display process in the job system according to the embodiment; and

FIG. 13 is a diagram illustrating an example of a report screen.

### DESCRIPTION OF EMBODIMENTS

The following illustrates details of embodiments with reference the accompanying drawings.

### System Configuration

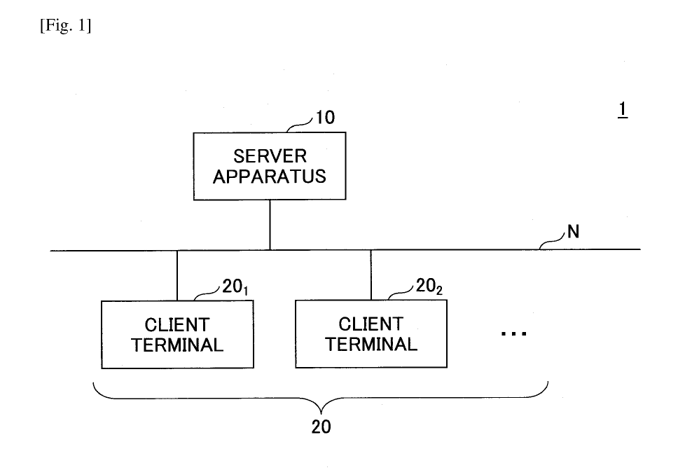

The following illustrates a system configuration of a job system 1 according to an embodiment with reference to FIG. 1. FIG. 1 is a diagram illustrating a system configuration example of the job system 1 according to the embodiment.

The job system 1 includes a server apparatus 10 and client terminals 20 that are communicatively coupled to one another via a network N including a local area network (LAN) or a virtual private network (VPN).

The server apparatus 10 is an information processing apparatus including a business process management system (BPMS) configured to implement business process management (BPM). The server apparatus 10 may, for example, execute a process (also referred to as a “job process” or a “business process”) to implement various types of jobs in corporate activities including marketing, sales, production, and human resource management in response to a request from the client terminal 20.

Note that the process includes an activity as one of work units (process units) of a job implemented by a pressure data process. That is, a process includes one or more activities.

The server apparatus 10 may further save logs of the process executed in response a request from the client terminal 20. The server apparatus 10 may create a report for assisting the improvement of the process based on the saved logs.

Note that an example of the job system 1 illustrated in FIG. 1 depicts the server apparatus 10 formed of one information processing apparatus; however, the job system 1 may include two or more server apparatuses 10 each formed of an information processing apparatus.

The client terminal 20 may be various types of terminal apparatuses operated by users. Examples of the terminal apparatuses include desktop personal computers (PCs), notebook PCs, smartphones, tablet terminals, and the like.

Note that there may be a job administrator who executes a process to implement a job, and a design engineer who designs and improves (redesigns) the process in the job system 1 according to the embodiment. In the following, the client terminal 20 used by a user who serves as the job administrator is called a “client terminal 20₁” and the client terminal 20 used by a user who serves as the design engineer is called a “client terminal 20₂”.

The distinction between the job administrator and the design engineer is provided merely for simplifying illustration, and the job administrator and the design engineer need not to be different users. That is, the same user may serve as both the job administrator and the design engineer.

The user who serves as a job administrator (hereinafter simply referred to as a job administrator user) may be able to operate the client terminal 20₁ to execute a process. The user who serves as a design engineer (hereinafter simply referred to as a design engineer user) may be able to operate the client terminal 20₂ to improve (redesign) the process based on the report created by the server apparatus 10.

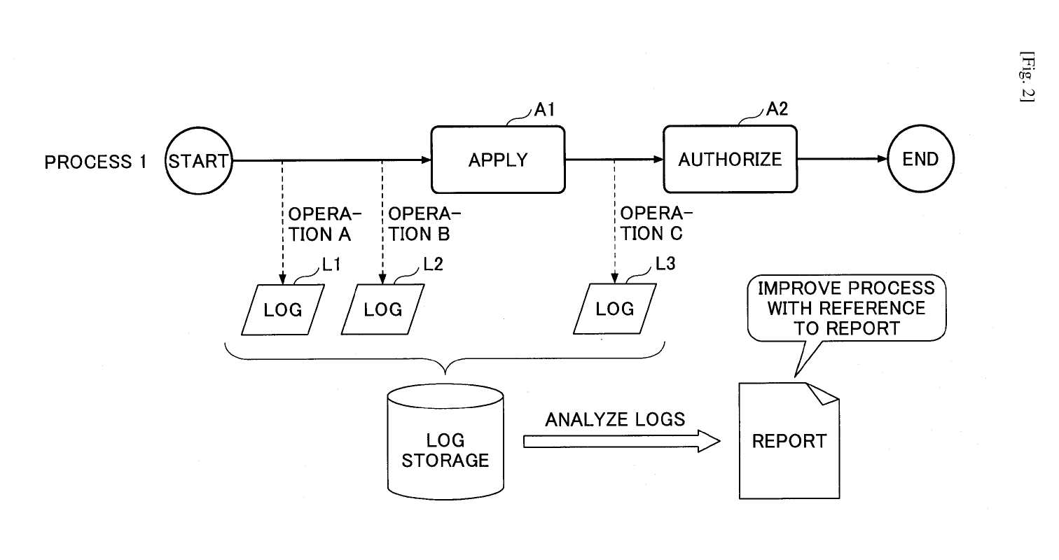

The following illustrates an overview of a process in the job system 1 according to the embodiment with reference to FIG. 2. FIG. 2 is a schematic diagram illustrating an example of a process in the job system 1 according to the embodiment.

FIG. 2 specifically illustrates an example of a process P1 formed of an activity A1 and an activity A2 executed in the job system 1 according to the embodiment.

In the job system 1 according to the embodiment, when the job administrator user performs an operation A (e.g., starts inputting characters) and an operation B (e.g., presses an application button) for executing the activity A1, a log L1 and a log L2 are created in response to the operation A and the operation B.

Similarly, when the job administrator user performs an operation C (e.g., presses an authorization button) for executing the activity A2, a log L3 is created in response to the operation C. Note that the activity A2 indicating authorization for the activity A1 may be a task or a process performed by a supervisor of the user who has performed the activity A1 or an authorizer at the authorization division.

Subsequently, in the job system 1 according to the embodiment, the created logs L1, L2, and L3 are saved in a log storage to accumulate the logs L1 to L3. The job system 1 according to the embodiment is configured to analyze logs accumulated in the log storage to create a report including operation errors detected locations and operation times.

As illustrated above, the job system 1 according to the embodiment accumulates logs by an operation unit for executing each of the activities included in the process. The job system 1 according to the embodiment creates a report including operation error detected locations and operation time based on the logs.

Thus, the design engineer user may be able to improve the process for preventing the operation errors of the job administrator user or reducing the operation time of the job administrator user, based on the created report in the job system 1 according to the embodiment. That is the job system 1 according to the embodiment may be able to assist the improvement of operability for executing a process.

Thus, the improvement (redesign) of the process in the job system 1 according to the embodiment indicates mainly the improvement (redesign) of a form used to perform the process.

Note that the form indicates a screen for executing each of the activities included in the process. For example, a vacation leave application process includes a vacation leave application form for executing a vacation leave application activity or a vacation leave authorization form for executing a vacation leave authorization activity. Similarly, an order placement application process includes an order placement application form for executing an order placement application activity or an order placement authorization form for executing an order placement authorization activity.

### Hardware Configuration

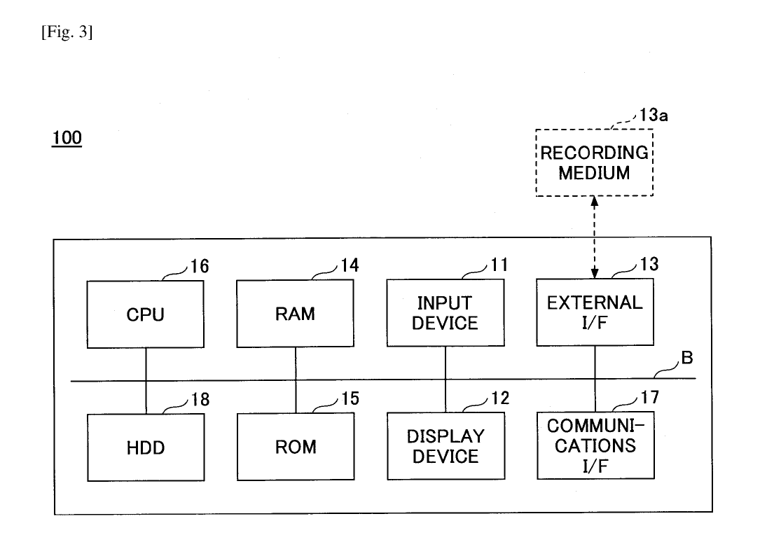

Next, a description is given of hardware configurations of the server apparatus 10 and the client terminal 20 of the job system 1 according to the embodiment with reference to FIG. 3. FIG. 3 is a diagram illustrating a hardware configuration example illustrating a computer 100 in the job system 1 according to the embodiment.

The computer 100 illustrated in FIG. 3 includes an input device 11, a display device 12, an external interface (I/F) 13, and a random access memory (RAM) 14. The computer 100 further includes a read only memory (ROM) 15, a (central processing unit) CPU 16, a communications I/F 17, and a hard disk drive (HDD) 18. The above-described hardware components are mutually coupled via a bus B.

The input device 11 includes a keyboard, a mouse, and a touch panel, and is configured to input various operation signals into the computer 100. The display device 12 includes a display and the like, and is configured to display various types of process results. The server apparatus 10 may optionally be coupled to the bus B to use the input device 11 or the display device 12.

The external I/F 13 is an interface between the computer 100 and external devices. Examples of the external devices include recording media including a compact disk (CD), a digital versatile disk (DVD), a secure digital (SD) memory card, and a universal serial bus memory (USB). The computer 100 may thus be able to read information from the recording media or write information on the recording media via the external I/F 13.

The RAM 14 is a volatile semiconductor memory (a storage device) configured to temporarily save programs and data. The ROM 15 is a non-volatile semiconductor memory (a storage device) configured to retain data even when the power supply is turned off. The CPU 16 includes one or more processors configured to load programs or data from the HDD 18 or the ROM 15 in the RAM 14 to execute the loaded programs to perform various types of processes.

The communications I/F 17 is an interface configured to couple the computer 100 to the network N.

The HDD 18 is a non-volatile storage memory (a storage device) storing programs and data. The programs or data stored in the HDD 18 include an operating system (OS), the basic software to control the computer 100 as a whole, and various types of programs (e.g., an image transmission program 40) running on the OS.

Note that the computer 100 may include a non-volatile memory (a storage device) such as a solid state drive (SDD) instead of the HDD 18 or in combination with the HDD 18.

The server apparatus 10 and the client terminal 20 of the embodiment may, for example, be implemented by the computer 100 illustrated in FIG. 3 that execute various types of processes described later.

### Functional Configuration

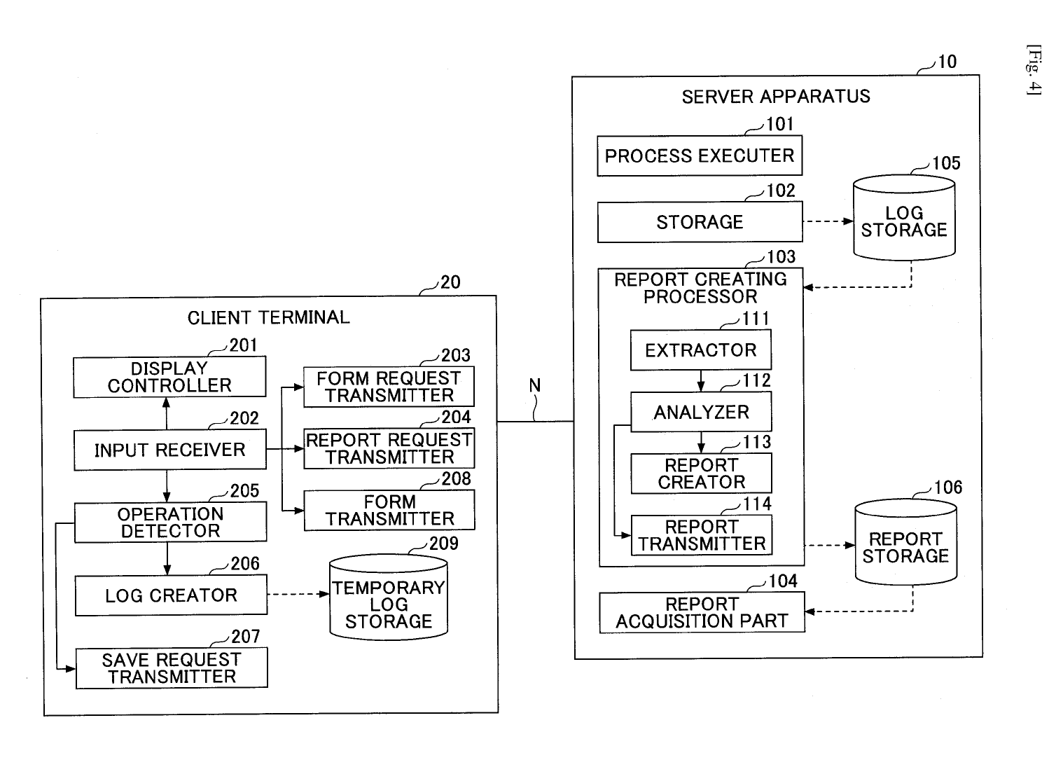

The following illustrates a functional configuration of the job system 1 according to the embodiment with reference to FIG. 4. FIG. 4 is a diagram illustrating a functional configuration example of the job system according to the embodiment.

The client terminal 20 illustrated in FIG. 4 includes a display controller 201, an input receiver 202, a form request transmitter 203, a report request transmitter 204, a log creator 206, a save request transmitter 207, and a form transmitter 208. The above components may be implemented by one or more programs installed in the client terminal 20 that cause a CPU 16 to execute processes.

The client terminal 20 further includes a temporary log storage 209 (a second storage). The temporary log storage 209 may be implemented by the HDD 18.

The display controller 201 is configured to display various types of forms received from the server apparatus 10 on the display device 102. For example, the display controller 201 may display a vacation leave application form for executing a vacation leave application activity included in a vacation leave application process on the display device 12.

The display controller 201 is configured to display reports received from the server apparatus 10. For example, the display controller 201 may display a report including operation error detected locations in the vacation leave application form and an operation time on the display device 12.

The input receiver 202 is configured to receive various types of inputs from a user. For example, the input receiver 202 may receive a character input start operation in each of the fields of the vacation leave application form. Note that the fields indicate input items included in a form (e.g., the vacation leave application form in this case). The fields may also be referred to as “form fields”. The form request transmitter 203 is configured to transmit an acquisition request of the form to the server apparatus 10. For example, the form request transmitter 203 may transmit an acquisition request of the vacation leave application form for executing the vacation leave application activity to the server apparatus 10, based on a start operation of the vacation leave application process.

The report request transmitter 204 is configured to transmit an acquisition request of a report to the server apparatus 10. For example, the report request transmitter 204 may transmit an acquisition request of the report in a form specified by the user to the server apparatus 10, in response to a display operation of the report operated by the design engineer user U₂.

The operation detector 205 is configured to detect operation events of various types of operations to the form received by the input receiver 202. For example, the operation detector 205 may detect operation events of various types of operations including an input start operation and an input end operation in the fields included in the vacation leave application form, a mouse click operation on an application button included in the vacation leave application form, and the like.

The log creator 206 is configured to create log data indicating logs (i.e., operation logs) in response the operation events detected by the operation detector 205. The log creator 206 is configured to save the created log data in the temporary log storage 209.

When an operation event of a predetermined operation is detected by the operation detector 205, the save request transmitter 207 is configured to transmit a save request of the logs including the log data saved in the temporary log storage 209 to the server apparatus 10.

Note that examples of the predetermined operation may include a transmission operation of the form, a closing operation of the form, and an interrupting operation of saving the input content of the form and interrupting the process. That is, the predetermined operation indicates an ending operation or an interrupting operation of the user to end or interrupt the input of the form.

The form transmitter 208 is configured to transmit form data that the user inputs in the form to the server apparatus 10 when a form transmission operation is received by the input receiver 202.

The temporary log storage 209 is configured to save the log data created by the log creator 206. The details of the log data saved in the temporary log storage 209 will be described later.

The server apparatus 10 illustrated in FIG. 4 includes a process executer 101, a storage 102, a report creating processor 103, and a report acquisition part 104. The above components may be implemented by one or more programs installed in the server apparatus 10 that cause a CPU 16 to execute processes.

The server apparatus 10 further includes a log storage 105 (a first storage) and a report storage 106. The above-described storage components may be implemented by using the HDD 18.

The process executer 101 is configured to execute a process based on form data received from the client terminal 20. For example, the process executer 101 may execute the vacation leave application activity based on form data of the vacation leave application form received from the client terminal 20. Note that the process executer 101 executes a process by executing activities included in the process.

The process executer 101 may further return (transmit) form display data for displaying one of the forms corresponding to the acquisition request in response to the acquisition request of the form from the client terminal 20. For example, the process executer 101 may return (transmit) the form display data for displaying the vacation leave application form in response to the acquisition request of the vacation leave application form from the client terminal 20.

The display device 102 is configured to cause the log storage 105 to save log data included in a save request in response to the save request of the log from the client terminal 20. The log data saved in the temporary log storage 209 of the client terminal 20 are thus accumulated in the log storage 105 of the server apparatus 10.

The report creating processor 103 is configured to create report data indicating a report for assisting the improvement of the process based on the log data stored in the log storage 105. The report creating processor 103 subsequently stores the created report data in the report storage 106. Note that the report creating processor 103 includes an extractor 111, an analyzer 112, a report creator 113, and a report transmitter 114. Details of the above-described components will be described later.

The report acquisition part 104 is configured to acquire report data indicating a report in association with a form specified by a user from the report storage 106, in response to the acquisition request of the report from the client terminal 20. The report acquisition part 104 subsequently returns (transmits) data for displaying a report (report display data) presented based on the acquired report data to the client terminal 20 serving as a request source.

The log storage 105 is configured to save log data saved by the storage 102. The details of the log data saved in the log storage 105 will be described later.

The report storage 106 is configured to save report data created by the report creating processor 103. The details of the report data saved in the report storage 106 will be described later.

The following illustrates details of the extractor 111, the analyzer 112, the report creator 113, and the report transmitter 114 included in the report creating processor 103.

The extractor 111 is configured to extract log data for creating a report from the log data saved in the log storage 105.

The analyzer 112 is configured to perform various types of analyses based on the log data extracted from the extractor 111 to create analyzed results.

For example, the analyzer 112 may perform a performance analysis to compute a mean input time for each of the fields included in the form and a heatmap analysis to compute coordinates of mouse click operated locations in the form. The analyzer 112 may further perform an exception analysis to compute operation errors detected in each of the fields included in the form and an associated form analysis to compute the number of reference times that the user refers to another form while the form is displayed.

The report creator 113 is configured to create reports based on the results of the analyses performed by the analyzer 112.

The report transmitter 114 configured to transmit a report to the design engineer user in accordance with the analyzed result computed by the analyzer 112. For example, the report transmitter 114 may transmit a report indicating that an operation error has been detected via a mail or the like to the design engineer user when the operation error is detected from the analyzed result of the exception analysis computed by the analyzer 112.

### Details of Process

The following illustrates details of the process of the job system 1 according to the embodiment.

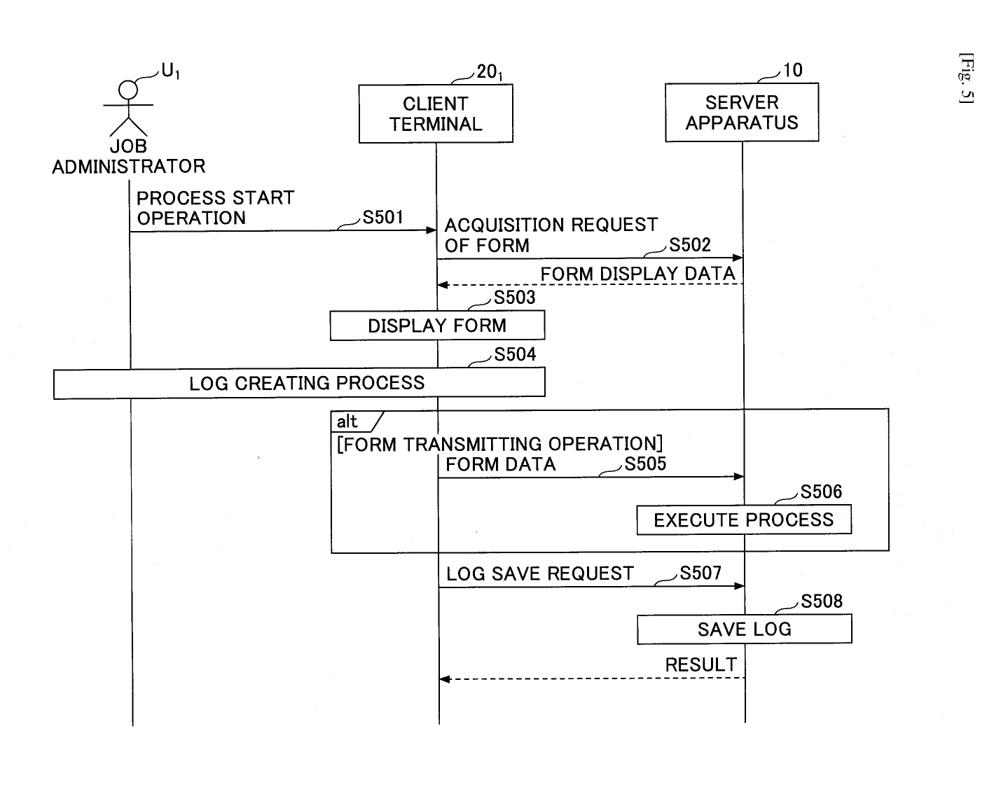

The following illustrates, with reference to FIG. 5, a process of storing operation logs of the job administrator user U₁ in the server apparatus 10 when the user U₁ executes the process using a client terminal 20₁. FIG. 5 is a sequence diagram illustrating an example of a log storage process in the job system 1 according to the embodiment.

The user U₁ performs a process start operation using the client terminal 20₁ (step S501). The input receiver 202 of the client terminal 20₁ then receives the process start operation.

The user U₁ may, for example, select a desired job from a list of jobs displayed on a browser or the like installed in the client terminal 20₁ to perform a process start operation for performing the selected job. In the following, it is assumed that the user U₁ has selected a “vacation leave application” from the list of jobs.

When the form request transmitter 203 of the client terminal 20₁ receives the process start operation of the vacation leave application process via the input receiver 202, the form request transmitter 203 transmits to the server apparatus 10 an acquisition request of the vacation leave application form for executing the vacation leave application activity included in the vacation leave application process (step S502). The process executer 101 of the server apparatus 10 then transmits a response of the form display data for displaying the vacation leave application form 1000 to the client terminal 20₁.

Note that a data format of the form display data may be any data format capable of displaying the form based on the form display data in the client terminal 20. An example of the data format of the form display data includes a hypertext markup language (HTML) data format.

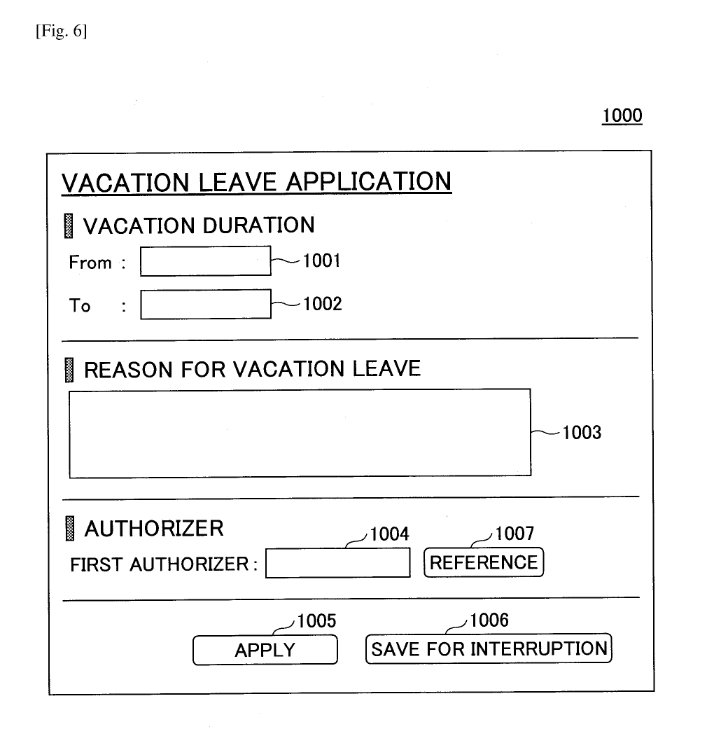

When the display controller 201 of the client terminal 20₁ subsequently receives the form display data for displaying the vacation leave application form from the server apparatus 10, the display controller 201 displays, for example, a vacation leave application form 1000 illustrated in FIG. 6 based on the received form display data (step S503).

Note that the vacation leave application form 1000 illustrated in FIG. 6 is a form for executing a vacation leave application activity included in the vacation leave application process. The vacation leave application form 1000 includes an input field 1001 for inputting a vacation leave start date, an input field 1002 for inputting a vacation leave end date, an input field 1003 for inputting a vacation leave reason, and an input field 1004 for inputting a first authorizer. The vacation leave application form 1000 further includes an application button 1005 for transmitting the vacation leave application form 1000 to execute the vacation leave application activity, and an interruption button 1006 for saving the input content of the form for interrupting the vacation leave application activity.

The vacation leave application form 1000 illustrated in FIG. 6 further includes a reference button 1007 for opening a form displaying a list of authorizers.

The vacation leave application form 1000 includes various types of fields for the job administrator user U₁ to input field values and various types of buttons for executing the activities with the field values input by transmitting the vacation leave application form 1000. The vacation leave application form 1000 may further include buttons for the job administrator user U₁ to refer to other forms for facilitating usage of the vacation leave application form 1000.

When the job administrator user U₁ performs various types of operations in the vacation leave application form 1000 illustrated in FIG. 6, the client terminal 20₁ creates log data for each of the operations, and saves the created log data in the temporary log storage 209 (step S504). Note that the details of the log creating process in step S504 will be described later.

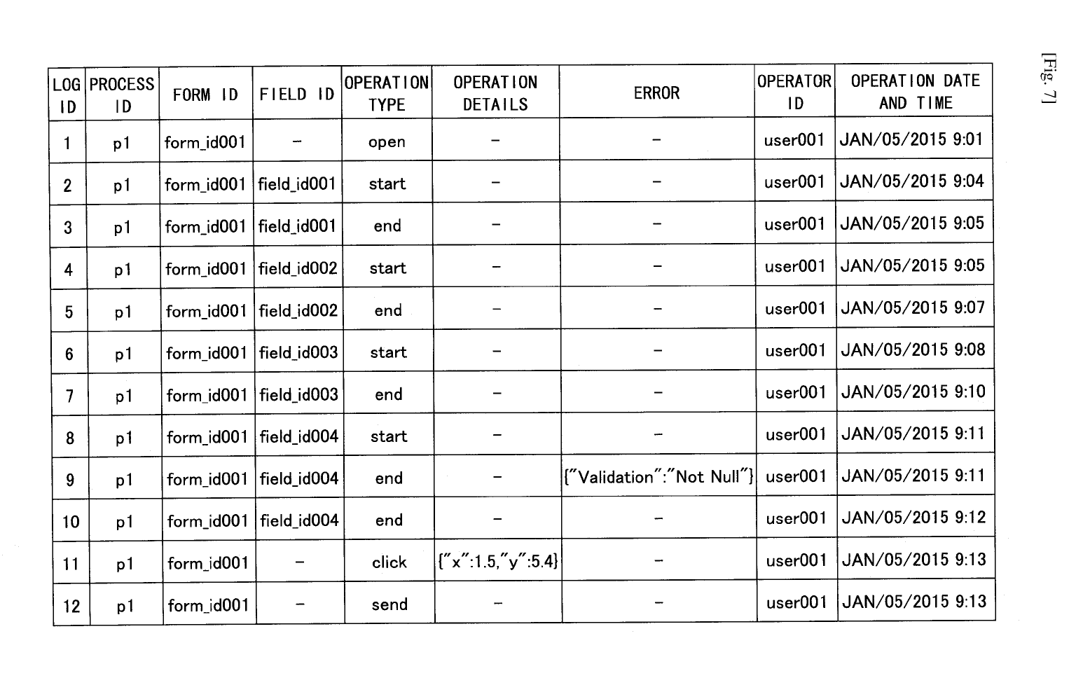

The following illustration is based on the assumption in which the log data illustrated in FIG. 7 are saved in the temporary log storage 209 after the above-described process of step S504.

The log data illustrated in FIG. 7 correspond to the user's operation logs in the form displayed on the display device 12 of the client terminal 20. The log data illustrated in FIG. 7 include data items of a log ID, a process ID, a form ID, a field ID, an operation type, operation details, an error, an operator ID, and operation date and time.

The “log ID” is identifier information to uniquely identify each of log data in the client terminal 20. The “process ID” is identifier information to uniquely identify each of processes. The “form ID” is identifier information to uniquely identify each of forms. The “field ID” is identifier information to uniquely identify each of fields included in the corresponding form.

The “operation type” is information indicating a type of the operation performed by the user U₁. For example, the operation type “open” indicates an operation to open a form. Hence, the log data including the operation type “open” indicates the log data created when the user U₁ has performed the operation to open the form.

Further, the operation type “start”, for example, indicates an operation to start inputting a value in the field. Similarly, the operation type “end”, for example, indicates an operation to end inputting a value in the field. Hence, the log data including the operation type “start” indicates the log data created when the user U₁ has performed the operation to start inputting a value in the field, and the log data including the operation type “end” indicates the log data created when the user U₁ has performed the operation to end inputting a value in the field.

Other examples of the operation types include “send” indicating an operation to transmit a form, “close” indicating an operation to close a form, and “save” indicating an operation to save the content input in the form and interrupt the process.

The “operation details” indicate coordinates of a clicked position in the form or coordinates of a hovering position in the form when the operation type indicates a mouse-related operation “click” or “hover”.

The “error” indicates content of an error when the error has occurred (i.e., when the error is detected). For example, the error corresponding to the log data having the log ID “9” (see FIG. 7) indicates a validation check that does not allow the operation to input a null value (NULL) in the field having the field ID “field_id004” when a user (user001) has performed the operation to input a value in the field having the field ID “field_id004”.

The “operator ID” is identifier information to uniquely identify each of users who has performed an operation in the form. An example of the operator ID may be a user ID. The “operation date and time” are date and time on which the user has performed an operation in the form.

The form transmitter 208 of the client terminal 20₁ transmits form data to the server apparatus 10 when the input receiver 202 has received a form transmission operation in the above-describe log creating process in step S504 (step S505). Note that the form data include field values input in the respective fields 1001 to 1004 of the vacation leave application form 1000.

When the process executer 101 of the server apparatus 10 receives the form data from the client terminal 20, the process executer 101 executes a vacation leave application activity based on the received form data (step S506). For example, the process executer 101 may transmit an authorization task for authorizing the applied content input in the vacation leave application activity to a user who is a first authorizer, based on the field value of a first authorizer input field 1004. The process executer 101 of the server apparatus 10 thus executes the vacation leave application process.

The save request transmitter 207 of the client terminal 20₁ transmits a save request of the log to the server apparatus 10 (step S507). Note that the save request includes the log data illustrated in FIG. 7.

When the storage 102 of the server apparatus 10 receives the save request of the log from the client terminal 20₁, the storage 102 saves the log data included in the save request in the log storage 105 (step S508). That is, the storage 102 stores the log data illustrated in FIG. 7 in the log storage 105. In this case, the storage 102 changes the log ID included in the log data illustrated in FIG. 7 to be uniquely specified in the server apparatus 10 and saves the changed log ID in the log storage 105.

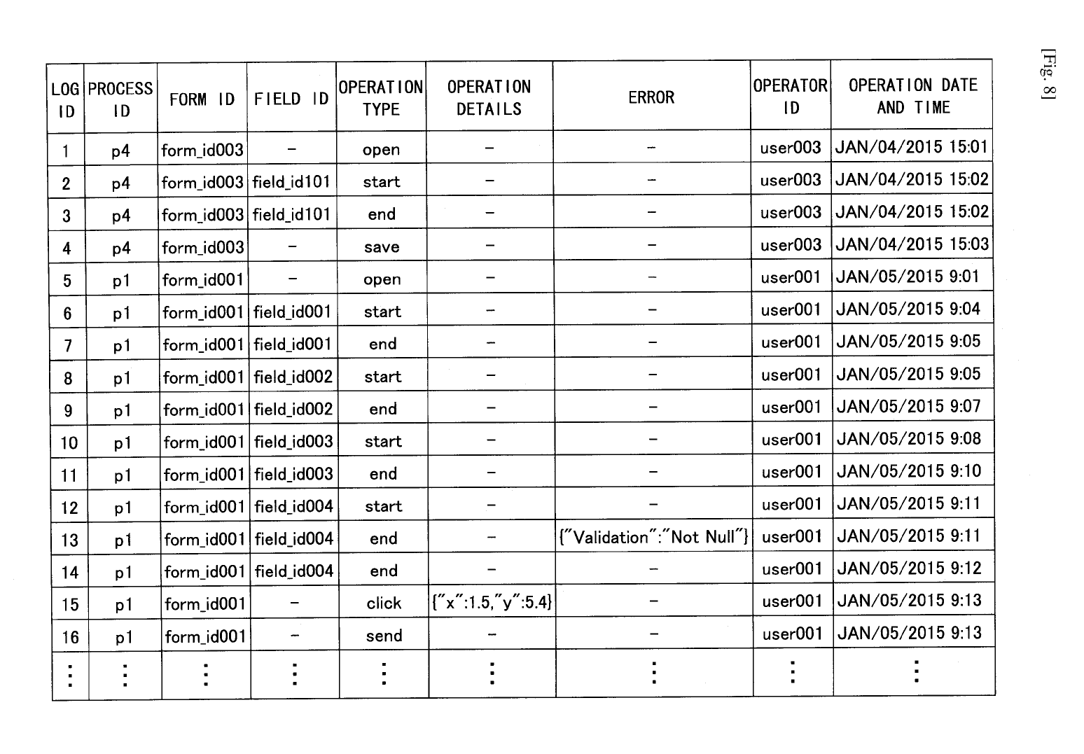

FIG. 8 illustrates the log data saved in the log storage 105. Among the log data illustrated in FIG. 8, the log data specified by the log IDs “5” to “16” that have been changed from the log IDs (“1” to “12”) illustrated in FIG. 7 are stored in the log storage 105. Thus, the storage 102 of the server apparatus 10 thus accumulates in the log storage 105 the log data included in the log save request received from the client terminal 20₁.

When the storage 102 saves the log data in the log storage 105, the server apparatus 10 transmits a result indicating that the log data have been saved in the log storage 105 to the client terminal 20₁ serving as a request source of the log save request. Note that the client terminal 20 that has received the result deletes the log data saved in the temporary log storage 209.

As illustrated above, when the job administrator user U₁ performs a process, the job system 1 according to the embodiment creates the operation logs in the form for executing the activities included in the process and accumulates the created operations logs. The job system 1 according to the embodiment creates a log by a unit of an operation performed by the user U1 to accumulate the created log.

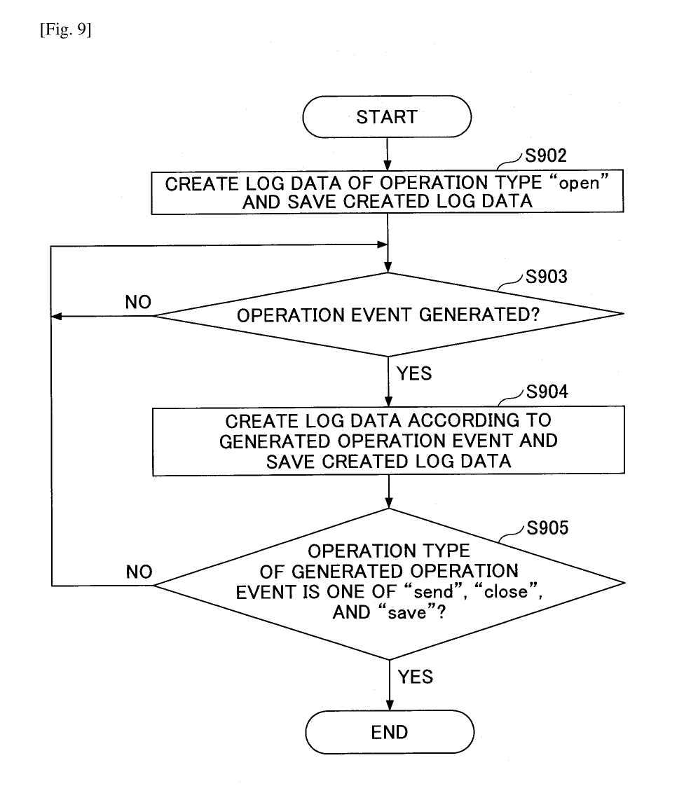

The following illustrated details of the log creating process of step S504 with reference to FIG. 9. FIG. 9 is a flowchart illustrating an example of the log creating process in the job system 1 according to the embodiment.

The log creator 206 of the client terminal 20 creates log data having the operation type “open” and saves the created log data in the temporary log storage 209 (step S902). Specifically, the log creator 206 creates the log data having the operation type “open” and save the created log data in response to the input receiver 202 that has received a process start operation performed by the user U₁ to open the vacation leave application form 1000.

The operation detector 205 of the client terminal 20 subsequently detects an operation event generated in response to the input receiver 202 that has received the operation by the user U1 (step S903). Specifically, the operation detector 205 detects operation events of various types of operations in the vacation leave application form 1000 received by the input receiver 202.

Note that the operation detector 205 may, for example, have a document object model (DOM) event detected by an event handler of JavaScript (registered trademark) as an operation event. For example, when an event is detected by an event handler “onFocus”, the operation detector 205 may detect an operation event having the operation type “start” that indicates an input start in the field. Similary, when an event is detected by an event handler “onBlur”, the operation detector 205 may detect an operation event having the operation type “end” that indicates an input end in the field. The operation detector 205 detects DOM events detected by the event handlers of JavaScript as the operation events.

The log creator 206 of the client terminal 20 subsequently creates log data based on the operation event detected by the operation detector 205, and saves the created log data in the temporary log storage 209 (step S904). For example, when the operation event having the operation type “start” is detected by the operation detector 205, the log creator 206 creates the log data of the operation type “start”, and saves the created log data in the temporary log storage 209. Hence, the log data corresponding to the unit of operation performed by the user U₁ in the form are saved in the temporary log storage 209.

Note that examples of the temporary log storage 209 include a session storage, a local storage, and closures of JavaScript.

The operation detector 205 of the client terminal 20 subsequently determines whether the generated operation event has any of the operation types “send”, “close”, and “save” (step S905). Specifically, the operation detector 205 determines whether the operation event of a predetermined operation has occurred. Examples of the operation event of the predetermined operation include an operation to transmit the vacation leave application form 1000 (transmission operation), an operation to close the vacation leave application form 1000 (a closing operation), and an operation to save the content input in the vacation leave application form 1000 to interrupt the process (an interruption operation).

When the operation detector 205 determines that none of the operation events of the operations “send”, “close”, and “save” has occurred in step S905, the client terminal 20 returns to a process in step S903. That is, the operation detector 205 of the client terminal 20₁ receives a next operation of the user U₁ from the input receiver 202 to detect the generated operation event of the next operation.

When the operation detector 205 determines that any one of the operation events of the operations “send”, “close”, and “save” has occurred in step S905, the client terminal 20₁ ends the process. That is, when the user U₁ performs a predetermined operation in the vacation leave application form 1000 (an input end operation or an input interruption operation in the form), the client terminal 20₁ ends the log creating process and saves the log data that have been saved in the temporary log storage 209 into the server apparatus 10.

As described above, the job system 1 according to the embodiment creates the operation logs performed in the form in a period between the user U₁ opening the form and the user U₁ closing the form in the client terminal 20₁ and saves the created operation logs. The job system 1 according to the embodiment collects the operation logs of the user U₁ while the form is displayed.

Note that the job system 1 according to the embodiment saves the operation logs in the temporary log storage 209 while the form is displayed, and transmits the operation logs saved in the temporary log storage 209 to the server apparatus 10 in response to the closing of the form. However, the embodiment is merely an example and not limited to this example. That is, the client terminal 20₁ may transmit an operation log to the server apparatus 10 every time the operation log is created while the form is displayed.

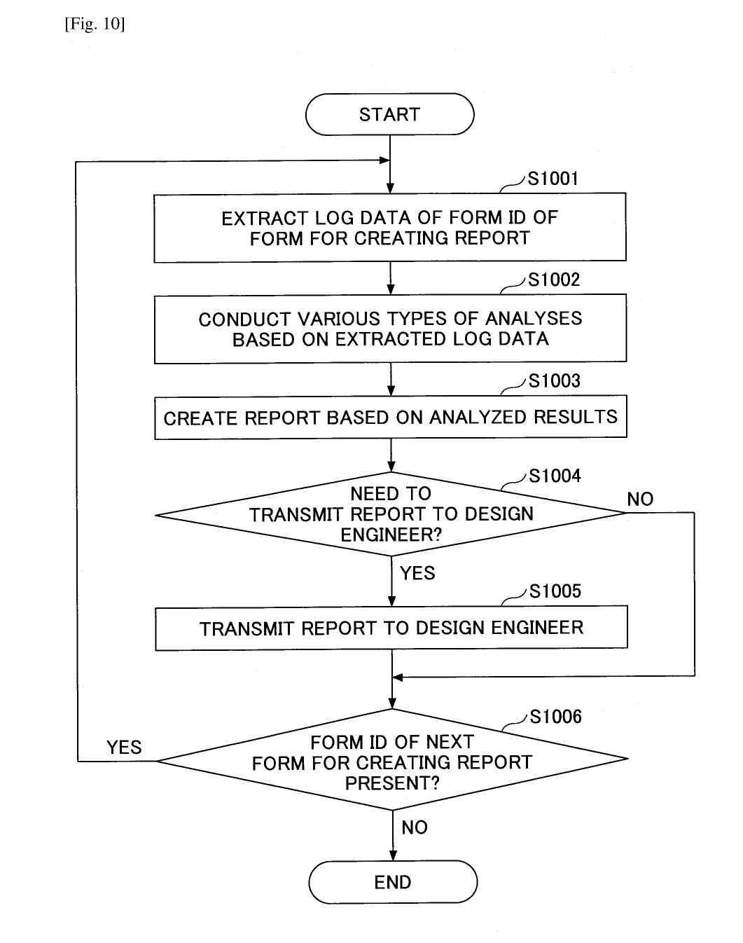

The following illustrates, with reference to FIG. 10, a report creating process for assisting the design engineer user U₂′ to improve (redesign) the process, based on the log data accumulated in the log storage 105 of the server apparatus 10. FIG. 10 is a flowchart illustrating an example of the report creating process in the job system 1 according to the embodiment. Note that in the following example, it is assumed that the report creating process illustrated below is executed in accordance with a predetermined schedule (e.g., the process is executed at predetermined time on a predetermined day of the week) set by the administrator of the job system 1 according to the embodiment. However, the design engineer user U₂ may manually execute the report creating process via the client terminal 20.

Initially, the report creating processor 103 of the server apparatus 10 causes the extractor 111 to extract log data of one of the form IDs of the forms subject to creating a report from the log storage 105 (step S1001). Note that the form IDs of the forms subject to creating a report are set in advance by the design engineer user U₂.

However, the form IDs of the forms subject to creating a report are not necessarily set in advance by the design engineer user U₂. For example, all the form IDs of the forms may be subject to creating a report, and the form ID of the form in a specific process may be subject to creating a report.

The report creating processor 103 of the server apparatus 10 subsequently causes the analyzer 112 to perform various types of analyses based on the log data extracted in step S1001 to create analyzed results (step S1002). Note that the analyses performed by the analyzer 112 in the embodiment include a performance analysis, a heatmap analysis, an exception analysis, and an associated form analysis. The respective analysis methods are noted in the following (1) to (4).

(1) Performance Analysis

The performance analysis is designed to compute the mean input time for each of the fields included in the form as an analyzed result.

Specifically, the mean input time for each of the fields included in the form may be computed by calculating the mean of the differences between the operation date and time of the operation type “end” and the operation date and time of the corresponding operation type “start” for the respective field IDs using the log data extracted in step S1001. The mean input time of the job administrator user U₁ who uses the form may thus be computed for each of the fields included in the form.

Note that the performance analysis may include the mean input time for each of the forms in addition to the mean input time for each of the fields. Specifically, the mean input time for the form may be computed by calculating the mean of the differences between the operation date and time of the operation type “close” or “send” and the operation date and time of the corresponding operation time “open” for the form using the log data extracted in step S1001. The mean input time of the job administrator user U₁ who uses the form may thus be computed.

(2) Heatmap Analysis

The heatmap analysis is designed to compute coordinates of the mouse-clicked locations or coordinates of the mouse-hovering locations in the form as an analyzed result.

Specifically, the coordinates of the mouse-clicked locations or coordinates of the mouse-hovering locations in the form may be computed by acquiring the log data in association with each of the operation types “click” and “hover” from the log data extracted in step S1001, and acquiring coordinates information from the operation details. The coordinates of the locations in the form mouse-clicked by the job administrator user U₁ or coordinates of the locations in the form mouse-hovering by the job administrator user U₁ may thus be acquired. The distribution (e.g., heatmap) of the operation events in the form generated by the mouse operation may thus be obtained.

(3) Exception Analysis

The exception analysis is designed to acquire exceptions including a field value error or an operation error generated for each of the fields included in the form as an analyzed result.

Specifically, such exceptions for each of the fields in the form may be acquired by obtaining the log data having an error setting from the log data extracted in step S1001 for each of the field IDs. The exception generated in each of the fields included in the form may thus be obtained.

(4) Associated Form Analysis

The associated form analysis is designed to acquire other forms being referred to and the number of times that each of other forms is referred to while the form indicated by the form ID subject to creating a report is displayed as analyzed results.

Specifically, other forms being referred to and the number of times that each of other forms is referred to while the form indicated by the form ID subject to creating a report is displayed are acquired from the log data extracted in step S1001 by referring to the log storage 105 for each of the operator IDs.

Then, the total number of reference times computed for each of the operator IDs may be obtained by each of the form IDs of other forms.

Other forms being referred to and the number of times that each of other forms is referred to while the form indicated by the form ID subject to creating a report is displayed may thus be acquired.

More specifically, when the operator ID is “user001”, the form opening time (form display time) of the operator ID “user001” may be computed from the log data of the operator ID “user001” included in the log data extracted in step S1001, for example. The form display time may be computed by the difference between the operation data time of the log data with the operation type “close”, “send”, or “save” and the operation date time of the log data with the operation type “open” corresponding to the operator ID “user001”.

Subsequently, whether there are any log data having the form ID(s) differing from the form ID subject to creating a report and having the operation date time within the form display time, among the log data corresponding to the operator ID “user001”, in the log storage 105 is determined. When it is determined that there are log data having the form ID of another form and having the operation date and time within the form display time, the form indicated by the corresponding form ID is recorded as another form being referred to while the form indicated by the form ID subject to creating a report is displayed, and the number of reference times that another form is referred to (while the form indicated by the form ID subject to creating a report is displayed) is recorded.

Finally, the total number of reference times that another form is referred to computed for each of the operator IDs is obtained by each of the form IDs of other forms. Thus, the number of reference times that another form is referred to is computed for each of the other forms.

Note that the above-described example illustrates that the analyzer 112 of the embodiment performs the performance analysis, the heatmap analysis, the exception analysis, and an associated form analysis; however, the analyses performed by the analyzer 112 are not limited to these analysis examples described above. For example, the analyzer 112 may conduct various types of analyses including a response analysis designed to compute the mean time from transmitting a form display request to displaying the form, and the like.

The report creating processor 103 of the server apparatus 10 subsequently causes the report creator 113 to create report data based on the analyzed results obtained in step S1002. The report creating processor 103 subsequently stores the report data created by the report creator 113 in the report storage 106 (step S1003).

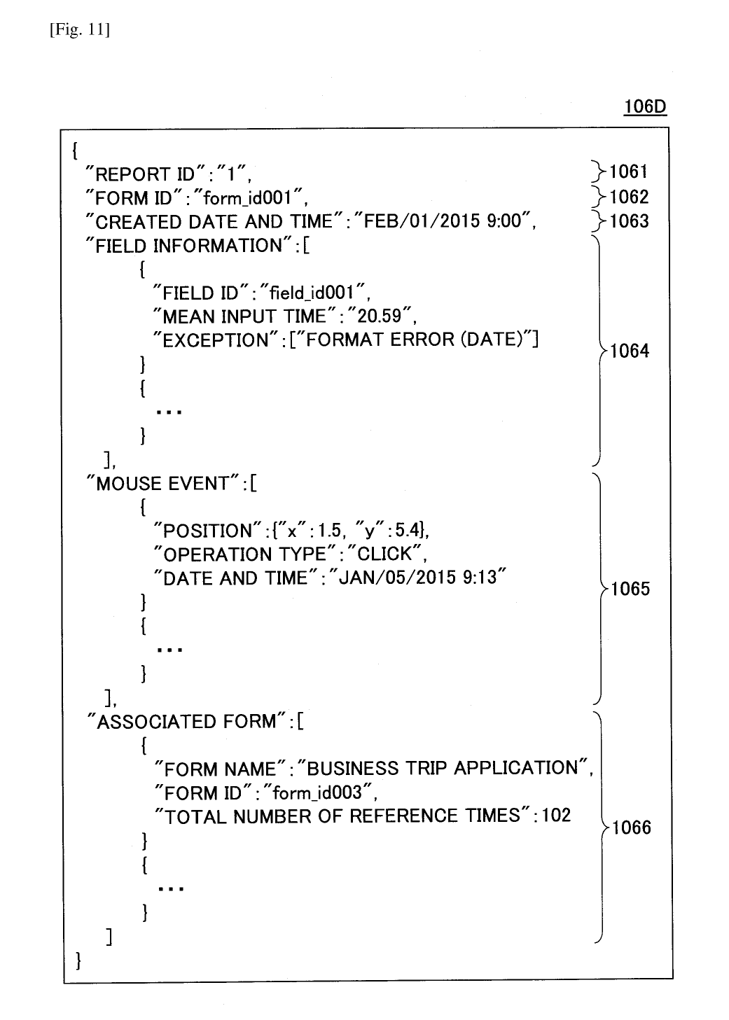

FIG. 11 illustrates an example of the report data created by the report creator 113. FIG. 11 is a diagram illustrating an example of report data 106D.

The report data 106D illustrated in FIG. 11 are created based on the performance analysis, the heatmap analysis, the exception analysis, and an associated form analysis.

The report data 106D illustrated in FIG. 11 includes a report ID 1061, a form ID 1062, created date and time 1063, field information 1064, a mouse event 1065, and an associated form 1066.

The report ID 1061 is identifier information to uniquely identify the report data 106D. The form ID 1062 is a form ID of the form subject to creating a report. The created date and time 1063 are date and time on which the 106d are created.

The field information 1064 includes the mean input time for the field and an exception generated in the field that are stored in an array for each of the fields. The field information 1064 illustrated in FIG. 11 includes, in the first array, the report ID “field_id001”, the mean input time “20.59”, and the exception “format error (date)”.

The field information 1064 is created based on the analyzed results of the performance analysis and the exception analysis.

The mouse event 1065 stores, in an array, the locational information where operation events associated with the mouse operation are generated. The mouse event 1065 illustrated in FIG. 11 stores, in the first array, the position indicating coordinates (“x”: 1.5, “y”: 5.4) at which an operation event associated with mouse operation is generated, the operation type “click” of the operation event, and date and time “Jan/5/2015 9:14” on which the operation event is generated.

The mouse event 1065 is created based on the analyzed result of the heatmap analysis.

The associated form 1066 stores, in an array, form information that is referred to while the form indicated by the form ID subject to creating a report is displayed. The associated form 1066 illustrated in FIG. 11 stores, in the first array, the form name of the form (reference form) that is referred to while the form having the form ID subject to creating a report is displayed, the form ID of the reference form, and the number of reference times of the reference form.

The associated form 1066 is created based on the analyzed result of the associated form analysis.

The following illustrates by referring back to FIG. 10. The report creating processor 103 of the server apparatus 10 causes the report transmitter 114 to determine whether a report needs to be transmitted to the design engineer user U₂ (step S1004). For example, when the field information of the report data created in step S1003 stores an exception, the report transmitter 114 may determine that the report needs to be transmitted to the design engineer user U₂. That is, when an exception is generated in the analyzed result of the exception analysis, the report transmitter 114 determines that the report needs to be transmitted to the design engineer user U₂.

The report transmitter 114 determines whether a report needs to be transmitted to the design engineer user U₂ based on the analyzed result of the exception analysis. Note that the report transmitter 114 may determine that the report needs to be transmitted to the design engineer user U₂ when the exception is generated a predetermined times or more in the fields included in the form or when predetermined exception set in advance is generated in the fields included in the form.

When report transmitter 114 determines that the report needs to be transmitted to the design engineer user U₂ in step S1004, the report creating processor 103 of the server apparatus 10 causes the report transmitter 114 to transmit to the design engineer user U₂ a report indicating, for example, that the exception is generated in the field included in the form (step S1005). Thus, when exception such as an operation error is generated in the field included in the form, the design engineer user U₂ may be able to detect the exception generated in the field.

Note that the report transmitter 114 may transmit the report by mail or the like to the design engineer user U₂. However, the report transmitter 114 does not necessarily transmit the report by mail. The report transmitter 114 may transmit the report by entering a task or the like for the design engineer user U₂.

The report creating processor 103 of the server apparatus 10 subsequently causes the extractor 111 to determine whether there is a next form ID subject to creating a report (step S1006).

When the extractor 111 determines that there is a next form ID subject to creating a report in step S1006, the report creating processor 103 returns to step S1001. In this case, the report creating processor 103 creates report data of the form indicated by the form ID subject to creating a next report.

When the extractor 111 determines that there is no next form ID subject to creating a report in step S1006, the report creating processor 103 ends the process.

In the job system 1 according to the embodiment, the server apparatus 10 performs various types of analyses based on the operation logs of the job administrator User U₁ and creates reports based on the analyzed results. The design engineer user U₂ may be able to improve (redesign) various types of forms for executing the process by referring to the thus created reports as described below.

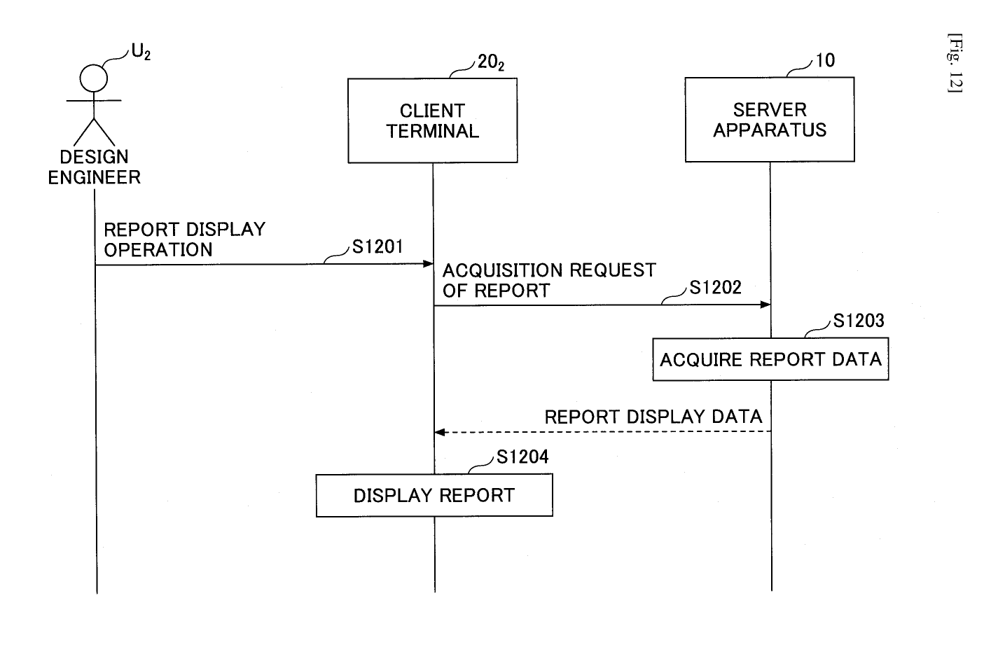

The following illustrates, with reference to FIG. 12, a report display process in which the design engineer user U₂ displays a report using a client terminal 20₂. FIG. 12 is a sequence diagram illustrating an example of a report display process in the job system 1 according to the embodiment.

The user U₂ performs a report display operation using the client terminal 20₂ (step S1201). The input receiver 202 of the client terminal 20₂ then receives the report display operation.

The user U₂ may, for example, select a desired form from a list of forms displayed on a browser or the like installed in the client terminal 20₂ to perform a report display operation for displaying the selected form. The following illustration will be given based on the assumption where the user U₂ has selected the “vacation leave application form” indicated by the form ID “form_id001” from the list of the forms.

When the report request transmitter 204 of the client terminal 20₂ receives the report display operation via the input receiver 202, the report request transmitter 204 transmits an acquisition request of the report for displaying the report to the server apparatus 10 (step S1202). Note that the acquisition request of the report includes the form ID “form_id001” of the vacation leave application form selected by the user U₂.

When the report acquisition part 104 of the server apparatus 10 receives the report acquisition request from the client terminal 20₂, the report acquisition part 104 acquires the report data having the form ID “form_id001” included in the acquisition request from the report storage 106 (step S1203).

The report acquisition part 104 then transmits report display data based on the acquired report data to the client terminal 20₂ serving as a request source of the report acquisition request.

Note that the report display data may indicate display data for displaying a report screen based on the report data in the client terminal 20₂. An example of the report display data may include HTML format display data created based on the report data. Note that the report display data may be in any data format capable of displaying a report screen in the client terminal 20₂. For example, when the client terminal 20₂ is capable of displaying a report screen based on the report data, the report acquisition part 104 may transmit the acquired report data in a data format without conversion to the client terminal 20₂.

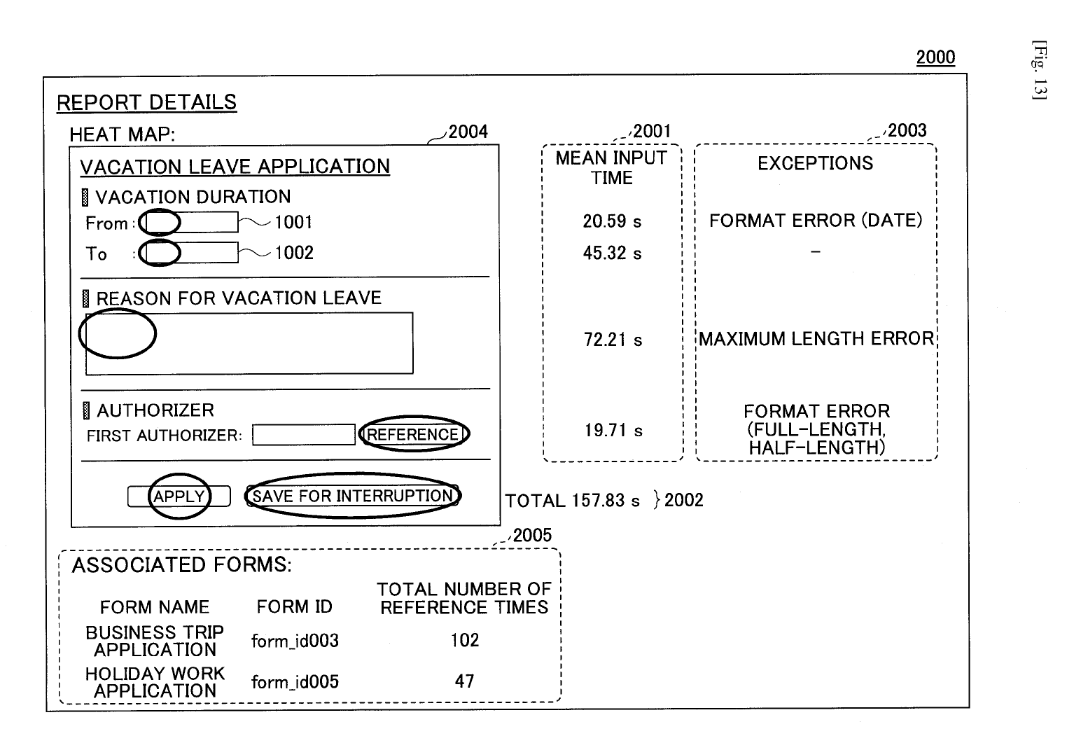

When the display controller 201 of the client terminal 20₂ receives the report display data from the server apparatus 10, the display controller 201 causes the display device 12 to display a report screen 2000 illustrated in FIG. 13, based on the received report data (step S1204).

The report screen 2000 illustrated in FIG. 13 is a screen displaying a report with respect to the vacation leave application form 1000. The report screen 2000 illustrated in FIG. 13 includes a display field 2001 displaying a mean input time for each of the fields included in the vacation leave application form 1000, a display field 2002 displaying a total mean input time of the fields, and a display field 2003 displaying exceptions occurring in each of the fields. The report screen 2000 further includes a display field 2004 displaying a heatmap obtained by mapping locations of operation events associated with a mouse operation in the vacation leave application form 1000 and a display field 2005 displaying associated forms being referred to while the vacation leave application form 1000 is displayed.

The design engineer user U₂ may thus be able to improve (redesign) a screen design or the like of the vacation leave application form 1000, based on the report details displayed on the report screen 2000. The user U₂ may specifically be able to improve (redesign) a process of the vacation leave application process by referring to the report details displayed on the report screen 2000.

For example, a display field 2001 displaying the mean input time illustrated in FIG. 13 displays the mean input time for each of the fields input by the job administrator user U₁. The display field 2001 displays the mean input time “20.59 s” for inputting vacation start date in the input field 1001 compared to the mean input time “45.32 s” for inputting vacation end date in the input field 1002.

The user U₂ may thus be able to recognize that an input operation in the input field 1002 takes longer than an input operation in the input field 1001. The user U₂ may be able to improve the vacation leave application form 1000 by providing the vacation leave application form 1000 with a calendar function such that the job administrator user U₁ is able to input dates in the input field 1001 and input field 1002 by referring to the calendar, for example, in order to reduce such a difference in the input operation between the two fields.

Similarly, the user U₂ may be able to improve input time in the vacation leave application form 1000 based on the total mean input time displayed in the display field 2002.

Further, a display field 2003 illustrated in FIG. 13 displays exception occurring for each of the fields. The user U₂ may be able to improve the vacation leave application form 1000 so as not to generate exceptions. For example, a format error has occurred in the input field 1001 of the vacation start date. Thus, the user U₂ may be able to improve the vacation leave application form 1000 so as not to allow the user U₁ to directly input a date but to allow the user U₁ to input the date by selecting from the calendar.

Further, a display field 2004 of a heatmap illustrated in FIG. 13, for example, displays a range in which the user U₁ has performed a mouse operation in the vacation leave application form 1000. The user U₂ may thus be able to improve the vacation leave application form 1000 based on the displayed range for the user U₁ to perform an optimized mouse operation.

In addition, a display field 2005 of associated forms illustrated in FIG. 13, for example, displays a total number of reference times of another form being referred to while the vacation leave application form 1000 is displayed. The user U₂ may thus be able to improve the vacation leave application form 1000 by providing, for example, the vacation leave application form 1000 with a link button linking to the form having the large number of reference times.

As described above, the design engineer user U₂ may be provided with a report displaying an analyzed result based on various types of operations in the forms in the job system 1 according to the above-described embodiment. Accordingly, the design engineer user U₂ may be able to make various types of improvements including reducing input time, preventing exceptions (e.g., an operation error) from occurring, and improving usability of the forms, based on the details displayed in the report. In the job system 1 according to the embodiment, the process improvement for improving the operability of the design engineer user U₂ may be assisted by providing the design engineer user U₂ with the report based on the operation logs of the job administrator user U₁.

The embodiments of the present invention are described above. However, the present invention is not limited to the specifically disclosed embodiments, and variations and modifications may be made without departing from the scope of the present invention.

### Reference Signs List

1 job system
10 server apparatus
20 client terminal
101 process executor
102 storage
103 report creating processor
104 report acquisition part
105 log storage
106 report storage
111 extractor
112 analyzer
113 report creator
114 report transmitter
201 display controller
202 input receiver
203 form request transmitter
204 report request transmitter
205 operation detector
206 log creator
207 save request transmitter
208 form transmitter
209 temporary log storage

The present application is based on and claims the benefit of priority of Japanese Priority Application No. 2015-166705 filed on Aug. 26, 2015, the entire contents of which are hereby incorporated herein by reference.

1. An information processing system for executing a job process, the information processing system comprising:
an acquiring unit configured to acquire an operation log of a user performance on a display screen for executing a process included in the job process;
a saving unit configured to save the acquired operation log in a first storage; and
a creating unit configured to create a report including information in association with the operation of the user performance on the display screen, based on the operation log stored in the first storage.

2. The information processing system according to claim 1, wherein the acquiring unit acquires the operation log of the user performance in a period between opening the display screen and closing the display screen.

3. The information processing system according to claim 2, wherein the acquiring unit acquires the operation log of the user performance on the display screen to save the acquired operation log in a second storage for temporarily storing the operation log, and
the saving unit saves the operation log that has been saved in the second storage into the first storage, in response to closing the display screen.

4. The information processing system according to claim 1, wherein the display screen includes one or more input items, and the creating unit creates a report including a mean input time corresponding to each of the input items in the display screen.

5. The information processing system according to claim 4, wherein the creating unit further creates a report including information in association with an exception generated in each of the input items.

6. The information processing system according to claim 1, wherein the creating unit creates a report including information in association with a number of reference times that the user refers to another display screen while the display screen is displayed.

7. An information processing apparatus configured to execute a job process, the information processing apparatus being coupled to a terminal apparatus via a network, the information processing apparatus comprising:
an acquiring unit configured to acquire an operation log of a user performance on a display screen for executing a process included in the job process, the display screen being displayed on the terminal apparatus;
a saving unit configured to save the acquired operation log in a first storage; and
a creating unit configured to create a report including information in association with the operation of the user performance on the display screen, based on the operation log stored in the first storage.

8. An information processing method for use in an information processing system having one or more processors programmed to execute a job process, the information processing method comprising:
acquiring an operation log of a user performance on a display screen for executing a process included in the job process;
saving the acquired operation log in a first storage; and
creating a report including information in association with the operation of the user performance on the display screen, based on the operation log stored in the first storage.
